(19) United States
(12) Patent Application Publication
(10) Pub. No.: US 2006/0107811 A1
(43) Pub. Date: May 25, 2006

(54) Laminate-cutting method, cutting device, and laminate-cutting pedestal

(75) Inventors: Yoshikazu Tanaka, Osaka (JP); Toshirou Nishikubo, Osaka (JP); Kazuo Kitada, Osaka (JP); Noriaki Hara, Osaka (JP); Sadaji Sutou, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/126,181

(22) Filed: May 11, 2005

(30) Foreign Application Priority Data
Nov. 22, 2004 (JP) 2004-337271

(51) Int. Cl. B26D 7/14

(52) U.S. Cl. 83/175

(57) ABSTRACT

The laminate-cutting method according to the present invention is a method for cutting an optical film wherein layers are laminated through a pressure-sensitive adhesive agent with a cutting edge, wherein the cutting of the laminate with the cutting edge is performed in the state that compressive stress applied to the optical film is decreased when the laminate is cut with the cutting edge. This makes it possible to provide a laminate-cutting method, a cutting device and a laminate-cutting pedestal wherein the generation of the adhesion of paste to a cutting edge, the blocking, cracking, chipping of cut faces, and others is prevented.

### FILED OF THE INVENTION

The present invention relates to a laminate-cutting method for cutting a laminate, a cutting device, and a laminate-cutting pedestal, in particular, a method for cutting a laminate wherein layers are laminated through a pressure-sensitive adhesive agent, a cutting device, and a laminate-cutting pedestal. The present invention also relates to a laminate and an optical film obtained by the laminate-cutting method, and an image display equipped with the laminate or film.

### BACKGROUND OF THE INVENTION

A laminate wherein layers are laminated through a pressure-sensitive adhesive agent interposed therebetween, such as an optical film, is cut by use of a cutting edge. Examples of the cutting edge include a Thomson edge for cutting in the state that a frame (having the shape of a product) is formed, and a single edge for cutting sides of a product one by one.

The cutting with a cutting edge, such as a single edge, is performed by placing a laminate on, for example, a plane pedestal. However, the cutting of the laminate by use of the plane pedestal has a problem that its paste (adhesive agent) adheres onto the cutting edge so that the edge is spoiled.

Against such a problem, for example, JP-A-2002-219686 discloses a film-cutting device equipped with a cutting edge and cushions which are arranged on both sides of the cutting edge and have a smooth and releasable surface having a small frictional coefficient.

However, the film-cutting device having the above-mentioned structure has a problem as follows: the adhesive agent of a laminate adheres onto the cutting edge and the cut faces of the laminate so as to be stuck out or pushed out, thereby sticking the cut faces onto each other again to cause the blocking of the cut faces. Furthermore, the device also has a problem that the cutting edge is pushed/pressed against the laminate, thereby generating internal stress inside the laminate so that the laminate is cracked or the cut faces are chipped.

### SUMMARY OF THE INVENTION

In light of the above-mentioned problems, the present invention has been made. An object thereof is to provide a laminate-cutting method, a cutting device and a laminate-cutting pedestal wherein sticking of a paste onto a cutting edge, blocking, cracking, chipping of cut faces, and others are prevented. Another object thereof is to provide a laminate and an optical film obtained by this cutting method, and an image display equipped with the laminate or film.

In order to solve the above-mentioned problems in the prior art, the inventors have made eager investigations on a laminate-cutting method, a cutting device, a laminate-cutting pedestal, and so on. As a result, the inventors have found out that the above-mentioned objects can be attained by adopting the following structures on the basis of analysis of cutting-behavior with a cutting edge by use of various pedestals, so as to complete the present invention.

Accordingly, the laminate-cutting method according to the present invention for solving the above-mentioned problems is a laminate-cutting method for cutting a laminate wherein layers are laminated through a pressure-sensitive adhesive agent with a cutting edge, wherein the cutting of the laminate with the cutting edge is performed in the state that compressive stress applied to the laminate is decreased when the laminate is cut with the cutting edge.

According to this method, the cutting of the laminate is performed in the state that compressive stress applied to the laminate is decreased when the laminate is pushed/pressed with the cutting edge; therefore, internal stress directed from the cut faces to the cutting edge is relieved in the cutting step. In this way, the degree of close adhesion between the cut faces and the cutting edge can be decreased. As a result, the so-called paste adhesion, which is adhesion of the adhesive agent onto the cutting edge, can be prevented. Furthermore, a part of the layers constituting the laminate can be prevented from being peeled since the abrasion of the cut faces with the cutting edge is decreased. After the cutting also, the generation of the sticking-out of the paste can be relieved. Accordingly, the degree of close adhesion between the cut faces is decreased to prevent the generation of the blocking of the cut faces.

It is preferred that the decrease in the compressive stress is performed in the state that tensile stress is applied to the front face side of the laminate and compressive stress is applied to the rear face side of the laminate.

When tensile stress is applied to the front face side of the laminate as described above, the cutting edge can be separated from the cut faces at an early stage. It is therefore possible to decrease paste adhesion onto the cutting edge, the sticking-out of the paste from the cut faces, and the generation of the above-mentioned blocking further. Moreover, at the time of pushing/pressing the laminate with the cutting edge, the compressive stress based on the cutting edge can be cancelled in the pushed/pressed region, so that the laminate can be made into an equilibrium state that no tensile stress or compressive stress is generated. As a result, the laminate is restrained from being cracked and the cut faces are prevented from being chipped. Thus, the precision of the (cutting) work can be improved.

It is preferred that a region where the laminate is to be cut with the cutting edge is rendered a region where tensile stress acts in forward and reverse directions substantially perpendicular to the direction of the cutting.

The region where tensile stress acts in forward and reverse directions substantially perpendicular to the direction of the cutting with the cutting edge as described above is cut, whereby the cutting edge can be certainly separated from the cut faces on both sides of the edge in the cutting step.

It is preferred that after the cutting also, tensile stress is caused to act onto the laminate in the forward and reverse directions substantially perpendicular to the cutting direction.

The laminate-cutting device according to the present invention for solving the above-mentioned problems is a laminate-cutting device comprising: a cutting edge for cutting a laminate wherein layers are laminated through a pressure-sensitive adhesive agent; a pedestal on which the laminate is placed, the pedestal having a placing-face having a surface shape for decreasing compressive stress applied to the laminate when the laminate is cut with the cutting edge; and a fixing means for fixing the laminate closely onto the pedestal.

According to this structure, the pedestal has the placing-face having the above-mentioned surface shape, which is for decreasing compressive stress applied to the front face side of the laminate when the front face of the laminate is pushed/pressed with the cutting edge; therefore, the cutting can be attained while internal stress directed from the cut faces to the cutting edge can be relieved in the cutting step. In this way, the degree of close adhesion between the cut faces and the cutting edge can be decreased so that the adhesion of the paste to the cutting edge can be prevented. Furthermore, a part of the layers constituting the laminate are restrained from being peeled since the abrasion of the cut faces with the cutting edge is decreased. After the cutting also, the generation of the sticking-out of the paste can be decreased by the pedestal having the above-mentioned structure. Accordingly, the degree of close adhesion between the cut faces is also decreased, so that the generation of the blocking can also be prevented.

It is preferred that the surface shape of the pedestal is a surface shape for generating tensile stress on the front face side of the laminate and generating compressive stress on the rear face side of the laminate.

In the case that the surface shape of the pedestal is a surface shape for generating tensile stress on the front face side of the laminate, as described above, the cutting edge can be separated from the cut faces at an early stage to make it possible to decrease the adhesion of the paste onto the cutting edge, the sticking-out of the paste from the cut faces, and the generation of the blocking further. The pedestal having the above-mentioned structure also makes it possible that when the laminate is pushed/pressed with the cutting edge, the compressive stress based on the cutting edge is cancelled in the pushed/pressed region. Thus, the laminate can be made into an equilibrium state that no tensile stress or compressive stress is generated therein. In this way, the laminate is restrained from being cracked and its cut faces are prevented from being chipped. Thus, the precision of the (cutting) work can be improved.

It is preferred that the surface shape of the pedestal is a surface shape for causing tensile stress to act in forward and reverse directions substantially perpendicular to the direction of the cutting in a region where the laminate is cut with the cutting edge.

As described above, in the case that the region where the pedestal generates, in the laminate, tensile stress in forward and reverse directions substantially perpendicular to the direction of the cutting with the cutting edge is rendered a cutting region, the cutting edge can be certainly separated from the cut faces on both sides of the edge in the cutting step.

It is preferred that after the laminate is cut also, the fixing means is fixed closely onto the pedestal. In this way, after the cutting also, tensile stress can be worked onto the laminate in the forward and reverse directions substantially perpendicular to the cutting direction.

The laminate-cutting device according to the present invention for solving the above-mentioned problems is a laminate-cutting device comprising: a cutting edge for cutting a laminate wherein layers are laminated through a pressure-sensitive adhesive agent; a pedestal on which the laminate is placed, the pedestal having a placing-face having a protruding line extending along the width direction of the laminate or a convex curved surface having a central axis extending along the width direction of the laminate; and a fixing means for fixing the laminate closely onto the pedestal.

As described above, the placing-face of the pedestal has a protruding line extending along the width direction of the laminate or a convex curved surface having a central axis extending along the width direction of the laminate. When the laminate is fixed closely to the pedestal with the fixing means, the laminate can be made into a state that tensile stress is applied onto the front face side of the laminate and compressive stress is applied onto the rear face side thereof. In this way, the cutting edge can be separated from the cut faces at an early stage in the cutting step, so as to make it possible to decrease the adhesion of the paste onto the cutting edge, the sticking-out of the paste from the cut faces, and the generation of the blocking further. This pedestal also makes it possible that when the laminate is pushed/pressed with the cutting edge, the compressive stress based on the cutting edge is cancelled in the pushed/pressed region. Thus, the laminate can be made into an equilibrium state that no tensile stress or compressive stress is generated therein. As a result, the laminate is restrained from being cracked and its cut faces are also restrained from being chipped. Thus, the precision of the (cutting) work can be improved.

It is preferred that in the case that the placing-face has the above-mentioned convex curved surface, which has a central axis extending along the width direction of the laminate, the curvature radius R of the curved surface ranges from 2 to 1000 mm.

When the curvature radius of the pedestal is set into this range, the tensile stress applied to the front face side of the laminate and the compressive stress applied to the rear face side thereof do not become excessive. As a result, the laminate is not cracked and further the adhesion of the paste onto the cutting edge and the generation of the blocking can be prevented.

The laminate-cutting pedestal according to the present invention for solving the above-mentioned problems is a laminate-cutting pedestal on which a laminate wherein layers are laminated through a pressure-sensitive adhesive agent is placed when the laminate is cut with a cutting edge, the pedestal having a surface shape for decreasing compressive stress applied to the laminate when the laminate is cut with the cutting edge.

Since the pedestal having the above-mentioned structure has a placing-face having the surface shape, which is for decreasing compressive stress applied to the surface of the laminate when the surface of the laminate is pushed/pressed with the cutting edge, the laminate can be cut in the state that internal stress directed from the cut faces to the cutting edge is relieved in the cutting step. This makes it possible to decrease the degree of close adhesion between the cut faces and the cutting edge and prevent the adhesion of the paste onto the cutting edge. Additionally, the pedestal having the above-mentioned structure also makes it possible to prevent the generation of the blocking on the basis of re-adhesion between the cut faces by the sticking-out of the paste from the faces.

It is preferred that the surface shape of the pedestal is a surface shape for generating tensile stress on the front face side of the laminate and generating compressive stress on the rear face side of the laminate.

As described above, in the case that the pedestal has a surface shape for generating tensile stress on the front face side of the laminate, the cutting edge can be separated from the cut faces at an early stage to make it possible to decrease the adhesion of the paste onto the cutting edge, the sticking-out of the paste from the cut faces, and the generation of the blocking further. The pedestal having the above-mentioned structure also makes it possible that when the laminate is pushed/pressed with the cutting edge, the compressive stress based on the cutting edge is cancelled in the pushed/pressed region. Thus, the laminate can be made into an equilibrium state that no tensile stress or compressive stress is generated therein. In this way, the laminate is restrained from being cracked and its cut faces are prevented from being chipped. Thus, the precision of the (cutting) work can be improved.

It is preferred that the surface shape of the pedestal is a surface shape for causing tensile stress to act in forward and reverse directions substantially perpendicular to the direction of the cutting in a region where the laminate is cut with the cutting edge.

As described above, in the case that the region where the pedestal generates, in the laminate, tensile stress in forward and reverse directions substantially perpendicular to the direction of the cutting with the cutting edge is rendered a cutting region, the cutting edge can be certainly separated from the cut faces on both sides of the edge in the cutting step.

The laminate-cutting pedestal according to the present invention for the solving the above-mentioned problems is a laminate-cutting pedestal on which a laminate wherein layers are laminated through a pressure-sensitive adhesive agent is placed when the laminate is cut with a cutting edge, wherein a placing-face on which the laminate is placed has a protruding line extending along the width direction of the laminate or a convex curved surface having a central axis extending along the width direction of the laminate.

According to this structure, the placing-face of the pedestal has the protruding line extending along the width direction of the laminate or the convex curved surface having the central axis extending along the width direction of the laminate; therefore, the laminate can be made into a state that tensile stress is applied to the front face side of the laminate and compressive stress is applied to the rear face side thereof when the laminate is cut. In this way, the cutting edge can be separated from the cut faces at an early stage after the cutting. Thus, the laminate can be worked in the state that the adhesion of the paste onto the cutting edge, the sticking-out of the paste from the cut faces and the generation of the blocking are decreased. The pedestal having the above-mentioned structure also makes it possible that when the laminate is pushed/pressed with the cutting edge, the compressive stress based on the cutting edge is cancelled in the pushed/pressed region. Thus, the laminate can be made into an equilibrium state that no tensile stress or compressive stress is generated therein. Consequently, the laminate is restrained from being cracked and its cut faces are restrained from being chipped when the laminate is cut. Thus, the precision of the (cutting) work can be improved.

It is preferred that in the case that the placing-face has the convex curved surface having the central axis extending along the width direction of the laminate, the curvature radius R of the curved surface ranges from 2 to 1000 mm.

This neither makes the tensile stress nor the compressive stress generated in the laminate excessive in the same manner as described above, so as to make it possible to prevent the generation of cracks in the laminate, the adhesion of the paste onto the cutting edge and the generation of the blocking.

The laminate according to the present invention for solving the above-mentioned problems is a laminate which is obtained by cutting a long laminate wherein layers are laminated through a pressure-sensitive adhesive agent with a cutting edge, the laminate being obtained in the state that compressive stress applied to the long laminate by the cutting edge is decreased when the long laminate is cut with the cutting edge.

The optical film according to the present invention for solving the above-mentioned problems is an optical film which is obtained by cutting a long optical film wherein layers are laminated through a pressure-sensitive adhesive agent with a cutting edge, the optical film being obtained in the state that compressive stress applied to the long optical film by the cutting edge is decreased when the long optical film is cut with the cutting edge.

The image display according to the present invention for solving the above-mentioned problems is an image display equipped with the above-mentioned optical film.

The present invention, by the means described above, produces advantageous effects described below.

The laminate-cutting method according to the present invention is performed in the state that compressive stress applied to laminate is decreased when the laminate is pushed/pressed with the cutting edge; therefore, it is possible to prevent the adhesion of the paste onto the cutting edge, the blocking based on the sticking-out of the paste from the cut faces, the cracking of the laminate, the chipping of the cut faces, and others. As a result, the production efficiency and the yield can be improved.

According to the laminate-cutting device according to the present invention, its placing-face has the protruding line extending along the width direction of the laminate or the convex curved surface, which has a central axis extending along the width direction of the laminate; therefore, the cutting edge can be separated from the cut faces at an early stage when the laminate is cut. This makes it possible to work the laminate while decreasing the adhesion of the paste onto the cutting edge and the generation of the blocking based on the sticking-out of the paste from the cut faces. Furthermore, the compressive stress applied to the laminate can be cancelled when the laminate is pushed/pressed with the cutting edge; therefore, the laminate is restrained from being cracked and its cut faces are also restrained from being chipped. Thus, the precision of the work is improved.

According to the laminate-cutting pedestal according to the present invention, its placing-face has the protruding line extending along the width direction of the laminate or the convex curved surface, which has a central axis extending along the width direction of the laminate; therefore, the cutting edge can be separated from the cut faces at an early stage when the laminate is cut. This makes it possible to work the laminate while decreasing the adhesion of the paste onto the cutting edge and the generation of the blocking based on the sticking-out of the paste from the cut faces. Furthermore, the compressive stress applied to the laminate can be cancelled when the laminate is pushed/pressed with the cutting edge; therefore, the laminate is restrained from being cracked and its cut faces are also restrained from being chipped. Thus, the precision of the work is improved.

### BRIEF DESCRIPTION OF THE DRAWINGS

Other objects, features and superior points of the present invention will be sufficiently understood from the following description. Advantages of the present invention will be made clear from the following description with reference to the attached drawings.

FIG. 1 is a view which schematically illustrates a device for cutting an optical film according to an embodiment of the present invention, and illustrates a situation that the optical film is cut with a cutting edge.

FIGS. 2(a) to 2(c) are each a schematic view which illustrates stress applied to the optical film conceptually, and FIG. 2(a) illustrates a state that the optical film is placed on a pedestal, FIG. 2(b) illustrates a state that the cutting of the optical film with the cutting edge is started, and FIG. 2(c) illustrates a state that the optical film is being cut with the cutting edge.

FIG. 3 is a perspective view which illustrates a region of the optical film cut with the cutting edge.

FIG. 4 is a schematic sectional view which illustrates the optical film according to the embodiment.

FIGS. 5(a) to 5(d) are each a schematic sectional view which illustrates a different embodiment of the pedestal according to the present invention.

### DESCRIPTION OF THE EMBODIMENTS

Embodiments of the present invention are described hereinafter, giving optical films as examples of the laminate of the invention.

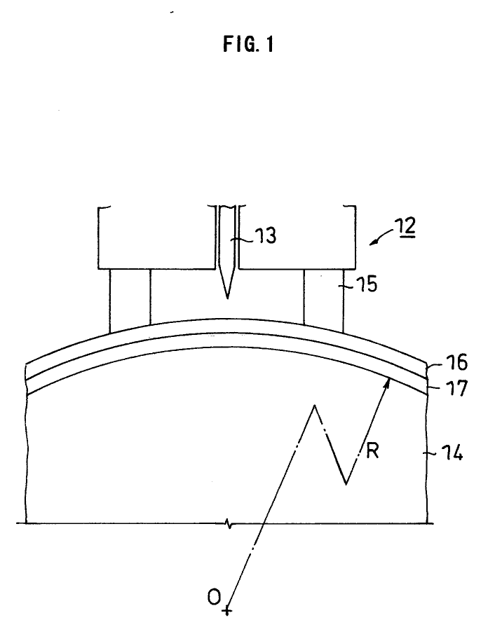

A laminate-cutting device according to an embodiment of the present invention is first described. FIG. 1 is a view which schematically illustrates the optical-film-cutting device according to the present invention. As illustrated in FIG. 1, the cutting device 11 has, as main constituting elements, a cutting unit 12 and a pedestal 14, and may have one or more different constituting elements. Examples of the different constituting elements include such as a transporting means for transporting an optical film 16.

The cutting unit 12 is a unit for cutting a long laminate, such as the optical film 16, and has a cutting edge 13 and a pair of elastic bodies 15 as a fixing means. The cutting edge 13 has a band-like shape extending straight, and is arranged substantially perpendicularly to the direction along which the optical film 16 is transported. The cutting edge 13 may be any one known in the prior art, and specific examples thereof include a super cutter.

The fixing means in the present invention may be any means that has a function of fixing the optical film 16 closely to the pedestal 14, which will be detailed later, when the optical film 16 is cut. The present embodiment is a case where the pair of elastic bodies 15 are used as the fixing means. The elastic bodies 15 push/press the optical film 16 from the upper surface thereof, thereby fixing the optical film 16 closely to the pedestal 14 without damaging the optical film 16. In FIG. 1, as each of the elastic bodies 15, a rectangular plate-like member is illustrated as an example thereof, but a member having a different shape may be used if necessary.

The material constituting the elastic bodies 15 is not limited to any especial kind, and may be selected from various materials known in the prior art. A specific example thereof is polyurethane. The elastic bodies 15 may be fitted to the cutting unit through spring mechanisms. The structure having the spring mechanism makes it possible to prevent the optical film 16 from being excessively pushed/pressed.

The pedestal 14 is a support on which the optical film 16 is placed when the optical film 16 is cut with the cutting edge 13. The placing-face of the pedestal 14 has a surface shape having a convex curved surface having a central axis extending along the width direction of the optical film 16 (see FIG. 1). In the cross section thereof, the curvature center thereof is represented by 0, and the curvature radius R of the curved face is preferably from 2 to 1000 mm, more preferably from 3 to 250 mm, even more preferably from 5 to 100 mm. When the curvature radius is set into this range, tensile stress applied to the front face side of the optical film 16 and compressive stress applied to the rear face side thereof can be made not to be excessive. As a result, the adhesion of the paste onto the cutting edge 13, the sticking-out of the paste, and the generation of the blocking, which results therefrom, can be prevented without cracking the optical film 16. Even if the curvature radius is within the above-mentioned range, a phenomenon that the film leaps up or some other phenomenon is caused after the film is cut so that the film may be injured when the used pedestal is a pedestal having such a curvature radius that stress is excessively applied to the film having a large hardness. Thus, the curvature radius R is preferably set to an optimal value in accordance with the material constituting the optical film, the hardness thereof, and others.

A lower plate 17 is interposed between the optical film 16 and the pedestal 14. The lower plate 17 is a member mainly for preventing abrasion, injures and other damages of the cutting edge 13, and further for preventing injures and other damages of the placing-face of the pedestal 14. The lower plate 17 is not limited to any especial kind, and may be adopted from various ones known in the prior art. A specific example thereof is a polystyrene sheet. The thickness of the lower plate 17 is not particularly limited, and is preferably from, e.g., 0.1 to 5 mm, considering the thickness of the optical film 16.

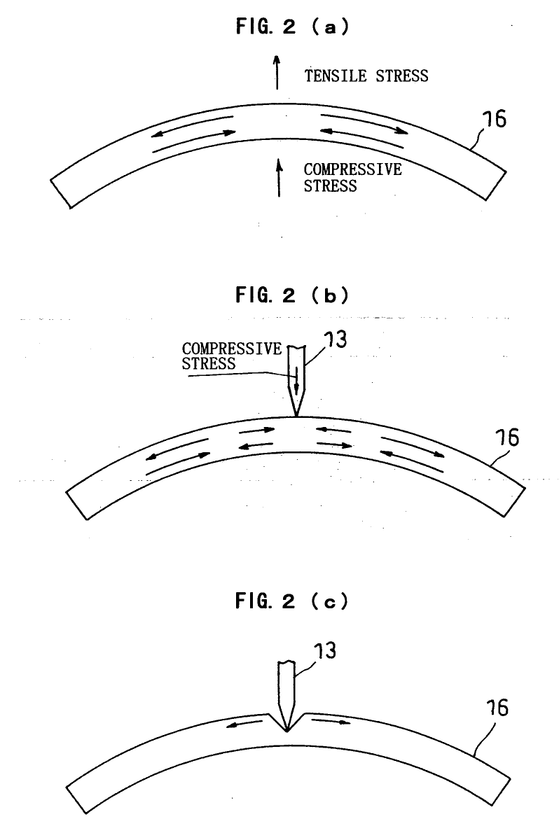

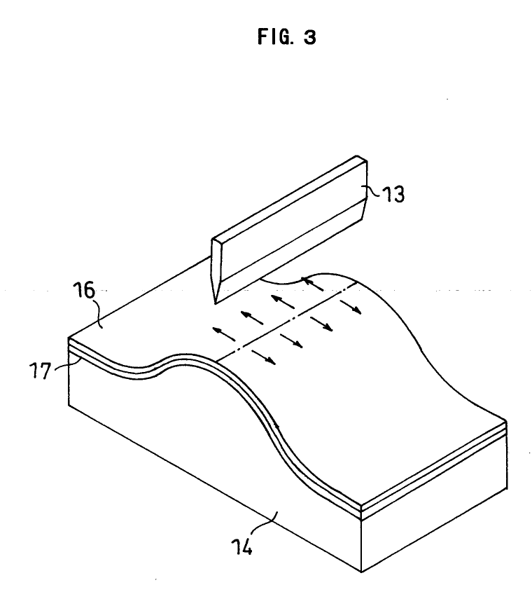

The following describes a laminate-cutting method using the cutting device 11. FIGS. 2(a) to 2(c) are each a schematic view which illustrates internal stress applied to the optical film conceptually, and FIG. 2(a) illustrates a state that the optical film is placed on a pedestal, FIG. 2(b) illustrates a state that the cutting of the optical film with the cutting edge is started, and FIG. 2(c) illustrates a state that the optical film is being cut with the cutting edge.

First, the long optical film 16 is transported to a position just under the cutting unit 12 by a transporting means, and the transporting speed is not particularly limited, and may be appropriately set in accordance with the situation. When the optical film 16 is transported to a given position, the cutting unit 12 is dropped so that the elastic bodies 15 first push/press the optical film 16. Consequently, the optical film 16 is fixed closely to the pedestal 14. At this time, bending deformation is generated in the optical film 16 on the basis of the surface shape of the placing-face of the pedestal 14. As a result, tensile stress is applied to the front face side of the optical film 16 and compressive stress is applied to the rear face side thereof by bending effect (see FIG. 2(a)).

Next, the cutting edge 13 is dropped to cut the optical film 16 while pushing/pressing the optical film 16. At this time, compressive stress is applied to the optical film 16 by the pushing/pressing of the cutting edge 13. However, the optical film 16 is in the state that the tensile stress is applied to the front face side of the optical film 16; therefore, the two are cancelled out each other at least in the cut region so that the internal stress is relieved (see FIG. 2(b)). As a result, the optical film 16 is not cracked. Cutting conditions, such as the cutting speed, are not particularly limited, and may be appropriately set in accordance with the situation.

When the cutting of the optical film 16 advances, the compressive stress based on the cutting edge 13 is lost in the cut portions (cut faces) and only the tensile stress is applied thereto; accordingly, the cut faces are immediately separated from the cutting edge 13 to prevent close adhesion between the cut faces and the cutting edge 13 (see FIG. 2(c)). In this way, friction between the cutting edge 13 and the cut faces can be prevented when the optical film 16 is completely cut with the cutting edge 13 and then the cutting edge 13 is again raised. As a result, the following are prevented: for example, the adhesion of the paste, which is the adhesion of the adhesive agent constituting a pressure-sensitive adhesive agent layer 23 onto the cutting edge 13; and the sticking-out of the paste. As a result thereof, the blocking caused by the contact between the cut faces is not generated. Additionally, good cutting can be attained without subjecting the cutting edge to releasing treatment or roughening treatment since the sticking-out of the paste can be prevented in the present invention as described above. For this reason, the maintenance of the cutting edge is made unnecessary, and further a cutting edge having a high cutting performance can be used. Additionally, a protective film, which will be described later, can be prevented from being peeled, and further the cut region is not chipped.

It is preferred to render the region which is cut with the cutting edge 13 a region where tensile stress acts in forward and reverse directions substantially perpendicular to the cutting direction, as illustrated in FIG. 3, for the following reason. In this region, the tensile stress acts substantially uniformly onto the cut portion, and both side faces of the cutting edge 13 are prevented from contacting the cut faces so that the adhesion of the adhesive agent onto the edge can be certainly prevented.

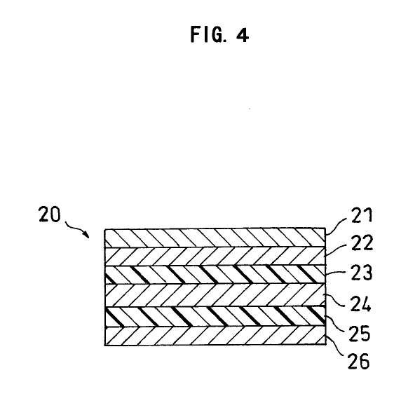

As illustrated in FIG. 4, an optical film 20 obtained by the laminate-cutting method according to the present embodiment has a structure wherein a polarizing plate 22 and a separator 26 are formed across adhesive agent layers 23 and 25, respectively, over respective faces of a phase difference film 24, and further a protective film 21 is formed on the polarizing plate 22.

The polarizing plate 22 has a structure wherein a protective layer is laminated on each of both surfaces of a polarizer.

The polarizer is produced by subjecting a hydrophilic polymer to appropriate treatments selected from swelling, dyeing, drawing, crosslinking and other treatments. The hydrophilic polymer is generally polyvinyl alcohol since it is good in the orientation of iodine or dichromatic dye therein in the dyeing treatment. In the present invention, however, the polymer is not limited to any especial kind. Specific examples of the polarizer include polyvinyl alcohol based films, partially-formalized polyvinyl alcohol based films, polyethylene terephthalate based films, ethylene/vinyl acetate copolymer based films, films obtained by saponifying these films partially, cellulose based films, other polymer films, and polyethylene based oriented films such as dehydrated polyvinyl alcohol films and films made of polyvinyl chloride from which hydrogen chloride is removed.

When the hydrophilic polymer is drawn, the total draw ratio thereof is set preferably into the range of 3 to 7 times, more preferably into the range of 4 to 6 times. If the total draw ratio is less than 3 times, a polarizing plate having a high polarization degree is not easily obtained. If the ratio is more than 7 times, the film tends to be easily fractured. The hydrophilic polymer may be gradually drawn into a total draw ratio of 3 to 7 times through the whole of the process including swelling, dyeing, drawing and crosslinking steps and other steps, or may be drawn into the above-mentioned total draw ratio in only one out of these steps. The hydrophilic polymer may be drawn plural times in any one of these steps.

The thickness of the polarizer is not particularly limited, and is generally from about 5 to 80 μm.

A film material that forms the protective layer, and the material having outstanding transparency, mechanical strength, heat stability and outstanding moisture interception property, etc. may be preferably used. As materials of the above-mentioned protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylnitrile-styrene copolymer. A film comprising mixture extruded article of resin compositions etc. may be used.

The protective layer is preferably a protective layer the phase difference of which is as small as possible. Considering this viewpoint, polarization property, endurance and others, it is preferred to use one out of cellulose based polymers. Of the cellulose based polymers, triacetylcellulose is more preferred. It is allowable to use a protective layer which contains fine particles so as to have a surface having fine irregularities.

The thickness of the protective layer is preferably 100 μm or less, more preferably 60 μm or less. For example, in the case of a thin polarizing plate, a triacetylcellulose (TAC) film having a thickness of about 40 μm can be used. In this case, it has been found out that this polarizing plate has a higher effect of restraining curling in the present invention than ordinary polarizing plates (TAC films having a thickness of 80 μm). This would be because: the former polarizing plate has a small total thickness so as not to exhibit rigidity; accordingly, the curling thereof is more easily affected by variation in the water content in the polarizing plate. The water vapor permeability of the protective layer is preferably within the range of 400 to 1000 g/m²24 h. Even if the water vapor permeability is out of this range, the effect of restraining curling in the present invention is high when a polarizing plate having a protective layer having a relatively high water vapor permeability is used. The water vapor permeability is the weight (g) of water vapor permeating a sample of 1 m² area at 40° C. and a relative humidity of 90% for 24 hours according to the moisture test (cup method) in JIS Z 0208.

In the case that two protective layers are formed on both faces of the polarizer, the two may be made of the same polymer material or different polymer materials.

In the case that a protective layer is stuck onto one surface of the polarizer and no protective layer is stuck on the other surface, the other surface may be subjected to a hard-coating-forming (hard coating) treatment, antireflective treatment, sticking-preventing treatment, or treatment for diffusion or antiglare.

The hard coating treatment is conducted to prevent the surface of the polarizing plate from being injured or attain other purposes. The hard coating can be formed by supplying, to the surface of the protective layer, a cured film which is good in hardness, slipping property and others and is made of an appropriate ultraviolet curing resin such as acrylic or silicone based resin. The antireflective treatment is conducted to prevent the reflection of external light on the surface of the polarizing plate, and can be attained by forming an antireflective film or the like according to a conventional method. The sticking-preventing treatment is conducted to prevent close adhesion between the polarizer and an adjacent layer.

The antiglare treatment is conducted to prevent the matter that external light is reflected on the surface of the polarizing plate to hinder light transmitted by the polarizing plate from being perceived, or to attain others. The antiglare treatment can be performed by giving fine irregularities to the surface of the protective layer in an appropriate manner, for example, a roughening manner (such as a sandblasting manner or an embossing manner), or the manner of incorporating transparent fine particles. The fine particles incorporated to form the above-mentioned fine irregularities (i.e., the fine irregularity surface structure) may be transparent inorganic fine particles which have an average particle size of 0.5 to 20 μm and may have electroconductivity; or transparent organic fine particles. The former particles may be made of silica, alumina, titania, zirconia, tin oxide, indium oxide, cadmium oxide, antimony oxide or the like, and the latter particles may be made of a crosslinked or uncrosslinked polymer, or the like. In the case of forming the fine irregularity surface structure, the amount of the used fine particles is generally from about 2 to 70 parts by weight, preferably from 5 to 50 parts by weight, per 100 parts by weight of the transparent resin which constitutes the fine irregularity surface structure. The antiglare layer may be a layer which also functions as a diffusion layer for diffusing light transmitted by the polarizing plate so as to enlarge the angle of visibility and the like (visual-angle-enlarging functions and other functions).

The antireflective layer, the sticking layer, the hard coating layer, the diffusion layer, the antiglare layer and other layers can be formed as protective layers per se, or may be formed as optically-functioning layers separated from any protective layer.

The phase difference film 24 is not limited to any especial kind. Examples thereof include ½ and ¼ wavelength films. The phase difference film may be a monolayer structure or a structure made of two or more layers in accordance with the situation. In this way, the film can be used as a circular polarization plate or an elliptical polarization plate also.

In the case that a field angle enlarging film is used instead of the phase difference film 24, the film is laminated over, for example, a polarizer through a pressure-sensitive adhesive agent layer, thereby yielding a polarizing plate having a wide field angle.

A reflective layer is prepared on a polarizing plate 22 to give a reflection type polarizing plate, and this type of plate is used for a liquid crystal display in which an incident light from a view side (display side) is reflected to give a display. A reflection type polarizing plate may be formed using suitable methods, such as a method in which a reflective layer of metal etc. is, if required, attached to the opposite to the side where a birefringent layer is accumulated. As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate 22, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transreflective type polarizing plate may be obtained by preparing the above-mentioned reflective layer as a transreflective type reflective layer, such as a half-mirror etc. that reflects and transmits light. A transreflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transreflective type polarizing plate. That is, the transreflective type polarizing plate is useful to obtain of a liquid crystal display of the type that saves energy of light sources, such as a back light, in a well-lighted atmosphere, and can be used with a built-in light source if needed in a comparatively dark atmosphere etc.

A method for laminating the polarizing plate 22 and the retardation plate 24 may be selected from the following various methods. For example, it is possible to illustrate a method of laminating the polarizing plate 22 onto the retardation plate 24 through the pressure-sensitive adhesive layer 23, a method of laminating the polarizing plate 22 onto the side of the retardation plate 24, which a protective layer is separated, through an adhesive layer, a method of laminating by the adhesive layer without separating the protective film, and a method of closely laminating through the adhesive layer without separating the protective film and using the adhesive layer. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates 24, birefringence films formed by stretching films comprising suitable polymers, such as polycarbonates, norbornene type resins, polyvinyl alcohols, polystyrenes, poly methyl methacrylates, polypropylene; polyallylates and polyamides; oriented films comprising liquid crystal materials, such as liquid crystal polymer; and films on which an alignment layer of a liquid crystal material is supported may be mentioned. A retardation plate 24 may be a retardation plate that has a proper phase difference according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

The polarizing plate 22 with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate 22, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling unevenness of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate 22 may consist of multi-layered film of laminated layers of a polarizing plate 22 and two of more of optical layers as the above-mentioned separated type polarizing plate. Therefore, a polarizing plate 22 may be a reflection type elliptically polarizing plate or a semi-transmission type elliptically polarizing plate, etc. in which the above-mentioned reflection type polarizing plate or a transreflective type polarizing plate is combined with above described retardation plate respectively.

The optical film 20 according to the present invention can be applied to various image displays such as a liquid crystal display and an electroluminescence (EL) display.

In the case that the optical film is applied to, for example, a transmission liquid crystal display, the liquid crystal display is formed by interposing a liquid crystal cell between a pair of transmission polarizing plates (or optical films). The transmission polarizing plates and the liquid crystal cell are stuck onto each other through a conventional adhesive agent or the like. The front polarizing plate on the display face side, out of the polarizing plates, and the rear polarizing plate on the rear side of the liquid crystal cell may be of the same kind or of different kinds. When the liquid crystal display is produced, one or more appropriate members or layers can be arranged at one or more appropriate positions, the members being selected from a diffusion plate, an antiglare layer, an antireflective film, a protective plate, a prism array, a lens array sheet, a light diffusion plate, a backlight and others.

The display mode of the liquid crystal display may be a TN (twisted nematic) mode, an STN mode, a VA (vertical aligned) mode, an OCB (optically self-compensated birefringence) mode, IPS (In Plane Switching) mode or some other mode.

An optical film 20 may be applied also to organic electro luminescence equipment device (organic EL display). Generally, in organic EL display, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarizing plate, while preparing the polarizing plate 22 on the surface side of the transparent electrode.

Since the retardation plate 24 and the polarizing plate 22 have function polarizing the light that has entered as incident light from outside and has been reflected by the metal electrode, they have an effect of making the mirror surface of metal electrode not visible from outside by the polarization action. If a retardation plate 24 is configured with a quarter wavelength plate and the angle between the two polarization directions of the polarizing plate and the retardation plate 24 is adjusted to π/4, the mirror surface of the metal electrode may be completely covered.

This means that only linearly polarized light component of the external light that enters as incident light into this organic EL display is transmitted with the work of polarizing plate 22. This linearly polarized light generally gives an elliptically polarized light by the retardation plate 24, and especially the retardation plate 24 is a quarter wavelength plate, and moreover when the angle between the two polarization directions of the polarizing plate 22 and the retardation plate 24 is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate 22, it cannot be transmitted through the polarizing plate 22. As the result, mirror surface of the metal electrode may be completely covered.

(Other Matters)

The above description is about the best modes of the present invention. However, the present invention is not limited to the above-mentioned embodiments, and can be modified within substantially the same scope as the technical concept described in claims of the present invention has, as described below.

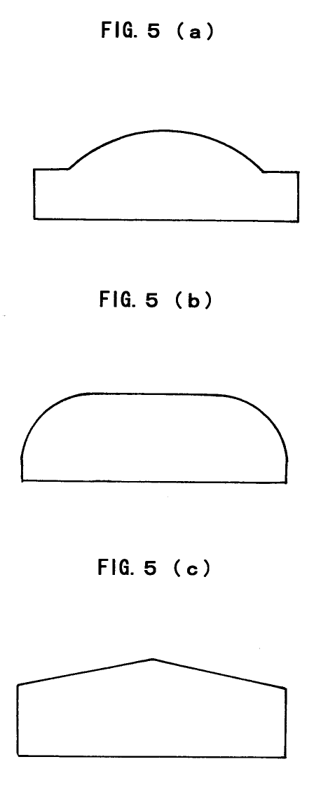

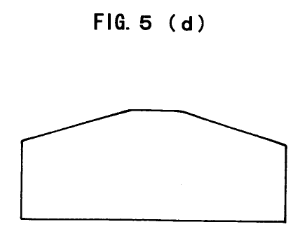

The cutting-pedestal according to the present invention is not limited to the above-mentioned pedestals. Specifically, pedestals having various shapes as illustrated in FIGS. 5(a) to 5(d) can be adopted. More specifically, as illustrated in FIG. 5(a), a pedestal having a structure having a curved face having a given curvature radius and a plane portion may be adopted. As illustrated in FIG. 5(b), a pedestal the top of which is in a plane form may be adopted. The area of the top can be changed into various values in accordance with the material of the laminate, cutting conditions, and others. As illustrated in FIG. 5(c), a mountainous pedestal having a cross section inclined at a given angle from the center thereof to both ends may be adopted. The inclination angle can be changed into various values in accordance with the material of the laminate, cutting conditions, and others. As illustrated in FIG. 5(d), a mountainous pedestal having a cross section the center of which is in a plane form may be adopted. In the case of using, for example, the pedestal having the sectional shape illustrated in FIG. 5(a), 5(b) or 5(d), it is preferred that the cutting region of a laminate is rendered a laminate region corresponding to the top (central portion) of the pedestal. In the case of using, for example, the pedestal having the sectional shape illustrated in FIG. 5(c), it is preferred that the cutting region of a laminate is rendered a laminate region corresponding to the folded portion of the pedestal. When the region corresponding to this portion is rendered a cutting region of a laminate, stress applied to the laminate can be concentrated only into the cutting area. Consequently, the cutting of the laminate becomes even easier.

The laminate according to the present invention is not limited to the above-mentioned optical films, and may be applied to various known laminates wherein layers are laminated through a pressure-sensitive adhesive agent.

The specific embodiments and examples described in the item “DESCRIPTION OF THE EMBODIMENTS” are merely embodiments and examples for making the technical content of the present invention clear. Thus, the invention should not be interpreted in a narrow sense so as to be limited to such specific examples. The invention can be modified within the scope of the spirit of the invention and the following claims.

What is claimed is:

1. A laminate-cutting method for cutting a laminate wherein layers are laminated through a pressure-sensitive adhesive agent with a cutting edge,
wherein the cutting of the laminate with the cutting edge is performed in the state that compressive stress applied to the laminate is decreased when the laminate is cut with the cutting edge.

2. The laminate-cutting method according to claim 1, wherein the decrease in the compressive stress is performed in the state that tensile stress is applied to the front face side of the laminate and compressive stress is applied to the rear face side of the laminate.

3. The laminate-cutting method according to claim 2, wherein a region where the laminate is to be cut with the cutting edge is rendered a region where tensile stress acts in forward and reverse directions substantially perpendicular to the direction of the cutting.

4. The laminate-cutting method according to claim 3, wherein after the cutting also, tensile stress is caused to act onto the laminate in the forward and reverse directions substantially perpendicular to the cutting direction.

5. A laminate-cutting device, comprising:
a cutting edge for cutting a laminate wherein layers are laminated through a pressure-sensitive adhesive agent,
a pedestal on which the laminate is placed, the pedestal having a placing-face having a surface shape for decreasing compressive stress applied to the laminate when the laminate is cut with the cutting edge, and
a fixing means for fixing the laminate closely onto the pedestal.

6. The laminate-cutting device according to claim 5, wherein the surface shape of the pedestal is a surface shape for generating tensile stress on the front face side of the laminate and generating compressive stress on the rear face side of the laminate.

7. The laminate-cutting device according to claim 6, wherein the surface shape of the pedestal is a surface shape for causing tensile stress to act in forward and reverse directions substantially perpendicular to the direction of the cutting in a region where the laminate is cut with the cutting edge.

8. The laminate-cutting device according to claim 7, wherein after the laminate is cut also, the fixing means is fixed closely onto the pedestal.

9. A laminate-cutting device, comprising:
a cutting edge for cutting a laminate wherein layers are laminated through a pressure-sensitive adhesive agent,
a pedestal on which the laminate is placed, the pedestal having a placing-face having a protruding line extending along the width direction of the laminate or a convex curved surface having a central axis extending along the width direction of the laminate, and
a fixing means for fixing the laminate closely onto the pedestal.

10. The laminate-cutting device according to claim 9, wherein in the case that the placing-face has the convex curved surface having the central axis extending along the width direction of the laminate, the curvature radius R of the curved surface ranges from 2 to 1000 mm.

11. A laminate-cutting pedestal, on which a laminate wherein layers are laminated through a pressure-sensitive adhesive agent is placed when the laminate is cut with a cutting edge,
the pedestal having a surface shape for decreasing compressive stress applied to the laminate when the laminate is cut with the cutting edge.

12. The laminate-cutting pedestal according to claim 11, the surface shape of which is a surface shape for generating tensile stress on the front face side of the laminate and generating compressive stress on the rear face side of the laminate.

13. The laminate-cutting pedestal according to claim 12, the surface shape of which is a surface shape for causing tensile stress to act in forward and reverse directions substantially perpendicular to the direction of the cutting in a region where the laminate is cut with the cutting edge.

14. A laminate-cutting pedestal, on which a laminate wherein layers are laminated through a pressure-sensitive adhesive agent is placed when the laminate is cut with a cutting edge,
wherein a placing-face on which the laminate is placed has a protruding line extending along the width direction of the laminate or a convex curved surface having a central axis extending along the width direction of the laminate.

15. The laminate-cutting pedestal according to claim 14, wherein in the case that the placing-face has the convex curved surface having the central axis extending along the width direction of the laminate, the curvature radius R of the curved surface ranges from 2 to 1000 mm.

16. A laminate, which is obtained by cutting a long laminate wherein layers are laminated through a pressure-sensitive adhesive agent with a cutting edge,
the laminate being obtained in the state that compressive stress applied to the long laminate by the cutting edge is decreased when the long laminate is cut with the cutting edge.

17. An optical film, which is obtained by cutting a long optical film wherein layers are laminated through a pressure-sensitive adhesive agent with a cutting edge,
the optical film being obtained in the state that compressive stress applied to the long optical film by the cutting edge is decreased when the long optical film is cut with the cutting edge.

18. An image display equipped with an optical film obtained by cutting a long optical film wherein layers are laminated through a pressure-sensitive adhesive agent with a cutting edge,
wherein the optical film is obtained in the state that compressive stress applied to the long optical film by the cutting edge is decreased when the long optical film is cut with the cutting edge.
